(19) United States
(12) Patent Application Publication
(10) Pub. No.: US 2006/0047741 A1
(43) Pub. Date: Mar. 2, 2006

(54) Method and device for quickly processing communication protocol by replacing software with hardware

(75) Inventor: Satoshi Funada, Tokyo (JP)

Correspondence Address: ERIC ROBINSON, PMB 955, 21010 SOUTHBANK ST., POTOMAC FALLS, VA, 20165, US

(73) Assignee: E-trees.Japan INC., Minato-ku (JP)

(21) Appl. No.: 10/519,187

(22) PCT Filed: Jun. 24, 2003
(86) PCT No.: PCT/JP03/07991

§ 371 Date: Dec. 22, 2004

(30) Foreign Application Priority Data
Jun. 26, 2002 (JP) 2002-186478

(51) Int. Cl. G06F 15/16

(52) U.S. Cl. 709/203

(57) ABSTRACT

A method and apparatus for implementing information transmission, computation, and especially Internet server functionality by means of hardware modules are provided. Software implementing an Internet server is converted to hardware by using a merging circuit module that merges input packets from a plurality of circuits into one output. A designer is free from a problem of complicated input/output timing control.

### TECHNICAL FIELD

The present invention relates to a method and apparatus for implementing information transmission, computation, and especially Internet server functionality by means of hardware modules. More specifically, the present invention relates to a method and apparatus for hardware implementation of interconnection and transfer of information and other signals between memory, input/output devices, and a central processing unit, and for hardware implementation of a web server, a mail server, an FTP server, and a DNS server using an integrated access control technique.

### BACKGROUND ART

Conventionally, various types of information transmission and computation have been performed as seamless processing using both a general-purpose computing device (computer) with one or more CPUs and special-purpose software. Examples of the information transmission and computation include data mining, natural language processing, network information processing (web-based information services, application processing, and information search), DNA computation simulators, physical simulation (characteristics analysis of new materials, protein structure prediction, planetary orbit prediction, etc.), and audio and video processing (real time compression and decompression).

Various types of information transmission and computation using a conventional CPU-based general-purpose computer have problems. That is, too much importance placed on processing versatility causes reduced processing speed and inability to achieve a required processing speed. For example, it is only after an instruction is read that the next processing is known, or a processing result varies the next instruction (data cannot be prepared in advance), or processing does not proceed until data is read from memory (the data read speed determines the processing speed).

By way of example, consider an Internet server that employs a method relying on a conventional CPU-based general-purpose computer. When intensive accesses from users are received on the server, the computer may not be able to process all requests from the users and may stop functioning, thereby making its Internet services unavailable. This results in lower reliability of the Internet infrastructure. Also, with future expansion of ADSL, SDSL, and optic cables, an extreme increase is expected in loads to be imposed on servers.

To avoid these problems, use of special-purpose computers is known to be advantageous. A special-purpose computer has an application-specific computation circuit. Therefore, use of a special-purpose computer for various types of information transmission and computation can achieve a desired processing speed without causing reduction in processing speed as with CPU-based general-purpose computers.

However, employing a special-purpose computer requires designing and producing an application-specific computation circuit. This poses a problem that it takes an enormous amount of designing time and production cost for each application.

FIG. 1 briefly illustrates a problem in designing a circuit of such a special-purpose computer. As shown in FIG. 1, a circuit typically has a plurality of inputs and outputs to process a plurality of signals in parallel. Therefore, timing among input values (a, b, c, and d), among output values (w, x, y, and z), and among input values and output values within the circuit presents complex aspects. If two or more circuits are to cooperate, the timing becomes further complex. Thus, since the timing control on the inputs and outputs associated with respective complexity is very difficult, designing the circuit is an arduous task.

In addition, conventional development of an apparatus that consists of hardware and software has been performed as follows in accordance with the apparatus specifications. First, its functionality is divided into a part performed by hardware and a part performed by software. Then, the hardware part and software part are separately developed in parallel based on the specifications. Lastly, the hardware part and the software part are integrated and verified for operation. Since the development progresses in this order, a problem arises that the software (or hardware) cannot be debugged until the hardware (or software) is completed. To solve this problem, debugging of the software (or hardware) has been performed by creating software (or hardware) that simulates the hardware (or software). However, this requires a process of creating the simulating software or hardware, which imposes extra labor.

The present invention has been made in view of these problems in the conventional techniques. It is an objective the present invention to provide a technique of providing an information transmission apparatus that ensures flexibility (versatility) of processing, enables high-speed processing, and uses a relatively small size of circuit.

### DISCLOSURE OF THE INVENTION

To achieve the above objective, the present invention provides a method of converting software into hardware modules and provides an information processing apparatus that uses hardware modules configured using this method, as described in detail below.

To convert a certain software program into hardware circuits, the software-hardware conversion method basically includes the steps of: dividing the software program into functional units; providing processing circuit modules, each performing processing operation corresponding to one of the functional units; providing a merging circuit module that merges inputs of data sets into one output; and combining the processing circuit modules with each other and optionally further combining the merging circuit module therewith so that the entire processing operation of the software program is implemented by hardware circuits. It is also possible to implement only certain functional units by hardware so that a software part implemented by a general-purpose computer and a hardware-implemented part coexist.

More specifically, the method includes the steps of: dividing a certain software program into one or more arbitrary functional units; providing a hardware-implemented processing circuit module that has zero or one input and zero or one or more outputs communicating the functional units via data sets of an arbitrarily variable length and performs certain processing operation based on the data sets; providing a merging circuit module that merges inputs of the data sets into one output; and combining one or more of the processing circuit modules with each other and optionally further combining inputs and an output of one or more of the merging circuit modules therewith so that processing operation of the software program is implemented by the hardware circuits.

The information processing apparatus using hardware modules according to the present invention basically includes: hardware modules, each configured by implementing one of functional units of certain information processing software as hardware; and signal transmission means for performing one-way transmission of data between the hardware modules on a data set basis. Typically, each functional unit of the software corresponds to a software component in which header and data information is communicated and processing is performed by, for example, a function call in C language.

More specifically, to perform hardware-implemented information processing, the apparatus according to the present invention basically includes one or more processing circuit modules and zero or one or more merging circuit modules. The processing circuit modules and the merging circuit modules perform one-way information transmission of packets containing certain information to/from the processing circuit modules, the merging circuit modules, or an I/O interface. Each of the processing circuit modules has a circuit for performing its specific functionality and has zero or one input and zero or more outputs. Each of the merging circuit modules has two or more inputs and only one output, and merges output packets from two or more circuits into one output.

As shown in FIG. 2 (a), an important aspect of the present invention is that signals are transmitted on a data set basis between an input or output device and a circuit block, or between circuit blocks. A circuit block receives an input packet containing values required for operation, performs certain processing within the circuit block, and outputs a packet containing resulting values. Since information transmission between the circuit blocks is on a packet set basis, a circuit block designer is freed from the problem of complex input/output timing control. Further, as shown in FIG. 2 (b), pipeline processing on a data set basis is possible. Therefore, the apparatus that includes these circuit blocks can efficiently perform a plurality of processes assigned thereto and increase the overall processing speed.

As used herein, a “circuit block” refers to a hardware module with one or more pieces of specific processing functionality that may be arbitrarily set by a designer. A circuit block is similar to a “function” in C language in software design. Circuit blocks used in the present invention include synchronous circuits, asynchronous circuits, sequential circuits, hardwired circuits, and microprocessor-based circuits.

Another important aspect of the present invention is employment of UPL (Universal Protocol Line) shown in FIG. 3. UPL is a generic term for information transmission mechanisms in an apparatus with circuit blocks that transmit information on a packet basis between the circuit blocks. In UPL, signal transmission between an input or output device and a circuit block or between circuit blocks is performed on a packet basis. UPL has a one-way characteristic such that an information packet is input to a circuit block, subjected to processing in the circuit block, and sent to the output as an information packet.

UPL consists of two kinds of rules (standards): UPL interfaces and UPL packets. The UPL interfaces involve physical rules for configuration of circuit blocks (bit width, data rate, data validation scheme, data encoding scheme, etc.). The UPL packets involve logical rules for configuration of information (packet format, etc.).

An apparatus that employs UPL includes two types of UPL circuits, namely “UPL processing circuits” and “UPL merging circuits,” whose inputs and outputs are simplified by the UPL technique. As shown in FIG. 4 (a), these two types of circuits can be combined in any manner to easily construct hardware that provides desired functionality.

A UPL processing circuit (FIG. 4 (b)) is a generic term for a circuit block that has input and output in accordance with the UPL standards. A UPL processing circuit has zero or one input UPL (an exemplary circuit with zero input UPL is an ocsillator) and zero or more output UPLs (a circuit with zero output UPL is a circuit with no UPL signal output, an example of which is a display device). A UPL processing circuit performs certain processing, such as computation, based on input data. It then outputs the result as a packet from a UPL output (if another circuit requires the result of the processing). Processing performed in a UPL processing circuit includes computation, delay, storage, and interfacing with an external I/O.

A UPL merging circuit (FIG. 4 (c)) is a circuit that has input and output interfaces in accordance with the UPL standards. A UPL merging circuit has two or more input UPLs and one output UPL. A UPL merging circuit does not perform any actual processing such as changing values but only has a capability of merging output packets from two or more circuit blocks into one UPL while avoiding collision of the packets. As stated above, designing a circuit that accepts a plurality of inputs with any timing is not easy. However, to achieve a desired circuit, it is essential to have a circuit that accepts a plurality of inputs with any timing. In the present invention, this hard-to-design feature of accepting a plurality of inputs with any timing is centralized in UPL merging circuits. A designer of the apparatus may focus his effort on UPL merging circuits to carefully design, implement, and debug the UPL merging circuits. Generally, once a UPL merging circuit is implemented, it may be reused as a library for other apparatus. As a result, the designer of the apparatus may focus his attention on designing, implementation, and debugging of UPL processing circuits, which have only one or zero input and is therefore relatively easy to design. This allows the designer to greatly improve the development efficiency and quality of the apparatus.

The UPL apparatus according to the present invention can be easily designed compared to conventional hardware special-purpose computers. As described above, each circuit block included in the UPL apparatus according to the present invention has one or more pieces of functionality, which are similar to functions in programming languages such as C. Then, a program written in a programming language such as C can be translated, with an appropriate translator (compiler), into a design drawing that is mainly based on gate arrays. Thus, the UPL apparatus according to the present invention can be easily designed without any special knowledge about circuit design.

In addition, in the UPL apparatus according to the present invention, both the hardware part and software part of the apparatus are initially written as a software program. Therefore, its operation can be verified without creating hardware part on a computer. Also, debugging for the developed hardware part can be performed using the software program underlying the hardware part. Therefore, debugging can be performed effectively in short time.

### BRIEF DESCRIPTION OF THE DRAWINGS

FIG. 1 shows inputs and outputs in a conventional circuit and their timing relationships;

FIG. 2 shows packet data-based inputs and outputs in a circuit according to the present invention and their timing relationships;

FIG. 3 shows a concept of UPL according to the present invention;

FIG. 4 conceptually shows an exemplary configuration of a large-scale UPL circuit according to the present invention;

FIG. 5 shows a function call using C language;

FIG. 6 shows correlation between modules using C language;

FIG. 7 shows correlation between modules using C language;

FIG. 8 shows correlation between modules using C language;

FIG. 9 shows a process of generating a packet by computation (processing);

FIG. 10 describes packet generation in detail;

FIG. 11 shows a function number and an argument structure;

FIG. 12 shows the role of UPL;

FIG. 13 shows a specific example of a UPL processing circuit;

FIG. 14 shows a specific example of a UPL merging circuit;

FIG. 15 conceptually shows the overall configuration of the present invention;

FIG. 16 conceptually shows an OSI layer model and UPL applied to the model;

FIG. 17 shows a receiving circuit and a sending circuit in an Nth layer;

FIG. 18 shows an embodiment of distributing a UPL large-scale circuit of the present invention on a plurality of LSI devices;

FIG. 19 shows embodiments of configuration for increasing the processing speed of the UPL circuits of the present invention;

FIG. 20 shows an embodiment of configuration for increasing the speed of memory access by the UPL circuits according to the present invention;

FIG. 21 shows an embodiment of processing external information by the UPL circuits according to the present invention;

FIG. 22 shows high compatibility of the UPL circuits of the present invention with software functions;

FIG. 23 shows an embodiment of configuration for implementing object-oriented software by hardware; and

FIG. 24 shows a concept of coordinative development of hardware and software in a UPL apparatus.

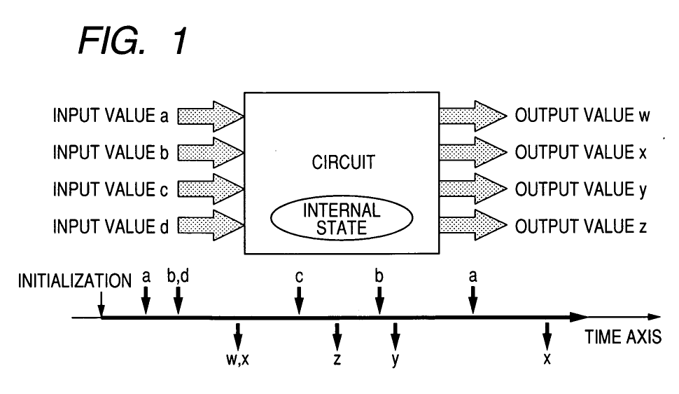

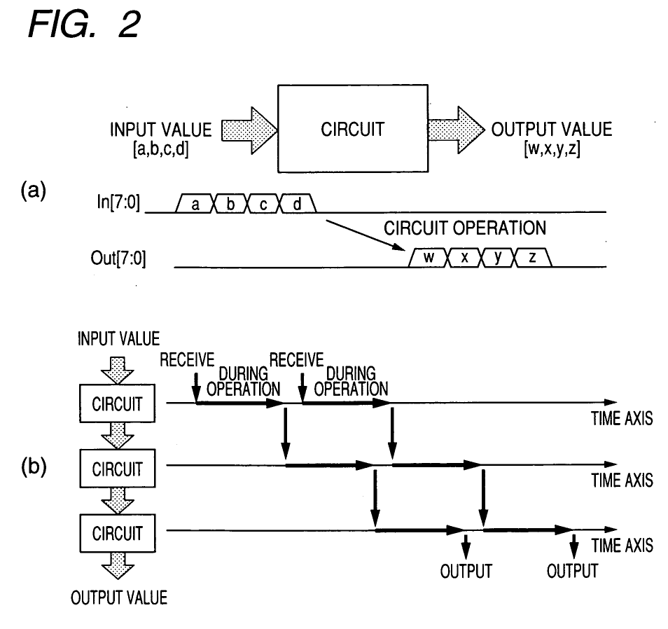

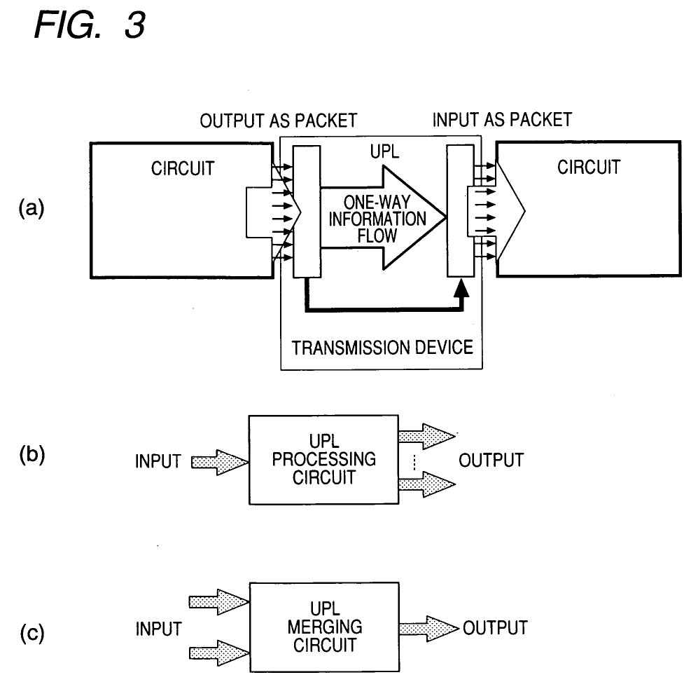

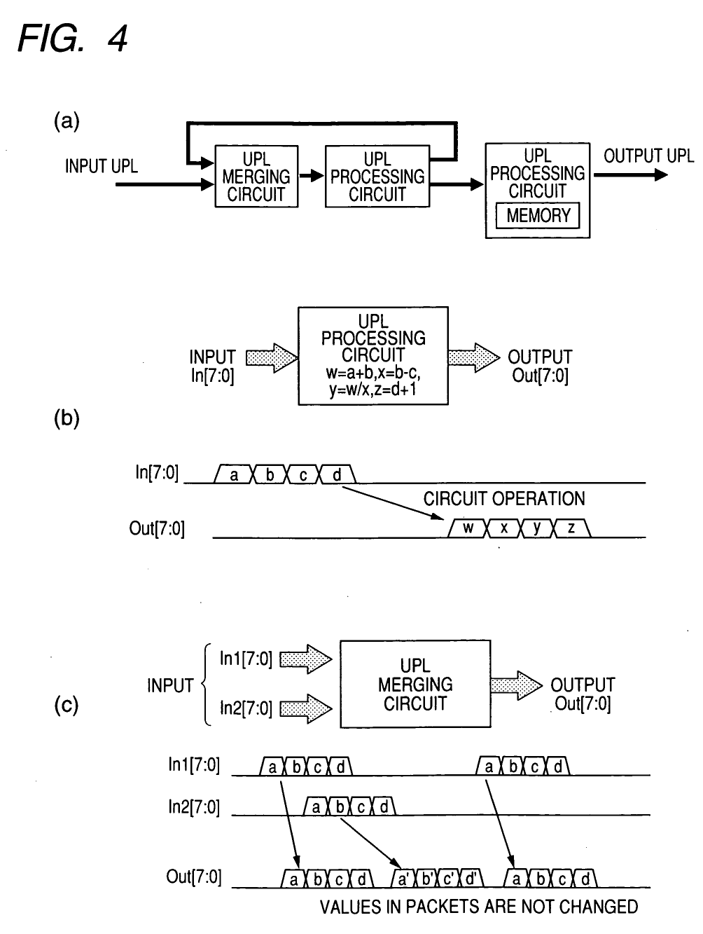

### EMBODIMENTS OF THE INVENTION

Now, embodiments of the present invention will be described in detail below referring to the drawings. The embodiments of the present invention will be described largely based on a UPL apparatus that implements Internet server functionality. However, it should readily occur to those skilled in the art that the present invention is not limited to Internet servers but may be applied to various types of information transmission and computation, such as data mining, natural language processing, network information processing, DNA computation simulators, physical simulation, and audio and video processing.

I. Software to be Implemented by Hardware

First, software to be implemented by hardware according to the present invention will be described.

Because software for information transmission and processing being developed today is very large in scale, it is extremely difficult for a single programmer to individually accomplish the development. Therefore, large-scale software is usually divided into functional units, each of which is assigned to one of programmers who independently undertake software development. Then, the separately developed software units are integrated to provide the whole software. In this manner, the programmers can focus their effort on development of individual functionality, which leads to the enhanced quality of the final product.

A problem in dividing software into units that have certain functionality (for example, a function) and separately developing the units is how to divide the software into the units and how to combine the units.

For this problem, various techniques have been proposed for different programming languages.

Among those techniques, the present invention employs a technique of “function call in languages such as C” to implement software partly or entirely by hardware.

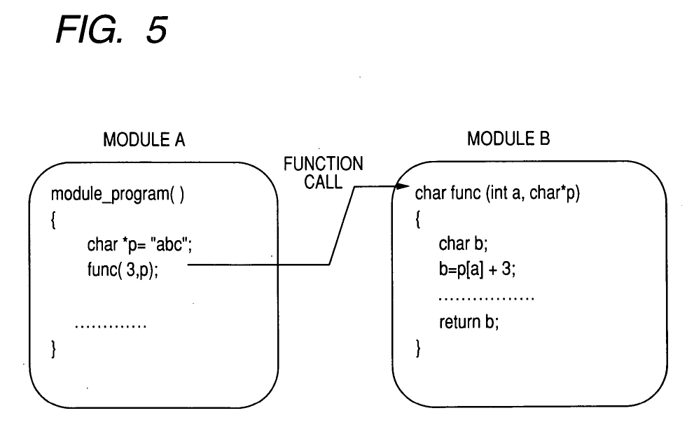

Now, a configuration of software to be implemented by hardware according to the present invention will be described. A part of software that implements a piece of functionality may be called a module. Software is made up of one or more modules, between which function calls are performed. The description below uses C as an exemplary programming language. Now, consider the case shown in FIG. 5, in which a module A calls a function func of a module B.

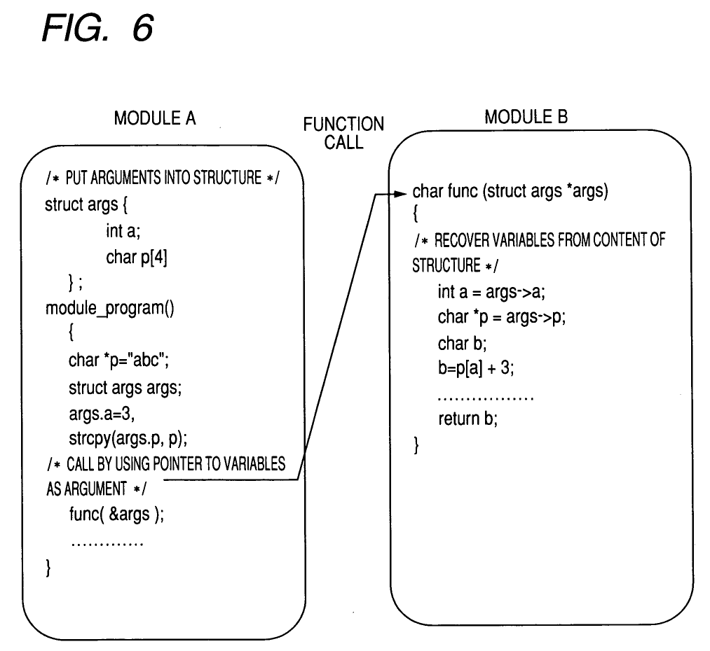

Typically, an argument is specified when a function is called. The called function performs processing according to the argument. Arguments for a function func may include fixed numbers such as integers and floating point numbers, as well as pointers that indicate a memory location (address). These values are typically written in an argument list. As shown in FIG. 6, this may be rewritten to perform the function call using a pointer variable as an argument.

Specifically, all arguments for the function are put into a structure. For an integer and a floating point number, their values are elements of the structure. For a pointer variable, the value of the location pointed to by the pointer variable is an element of the structure.

The called function receives a pointer to the structure as an argument of the function. The function reconstructs arguments from the structure to perform intended processing.

Thus, in software programming languages, information is exchanged between modules by putting original arguments into a structure and calling only a pointer to the structure as an argument. In the present invention, data packets similar to this argument structure are used to exchange information between modules of a software program implemented by hardware.

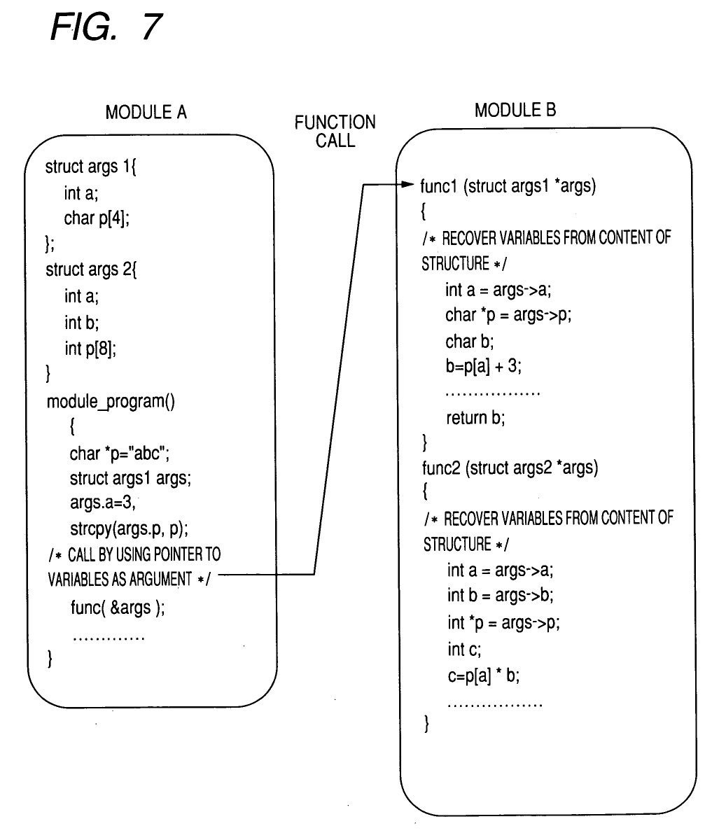

Next, consider the case where a module includes a plurality of functions. As shown in FIG. 7, a module B includes two functions, func1 and func2. From the viewpoint of hardware implementation, having a comprehensive and common hardware interface may make the size of circuitry small (this may also be important from the viewpoint of reducing power consumption and saving transistors). This can be achieved by reducing what corresponds to the functions to be called from a module A to one. That is, to provide a comprehensive and common argument for the functions, a function number of a function intended to be called is included as an element in the above-described structure. Thus, even if the definition of the argument structure varies for each function, it can be determined which structure's definition is used by referring to the function number. Conversely, it may be considered that the function number represents which type of structure is used, and which function is required for processing using that structure as an input.

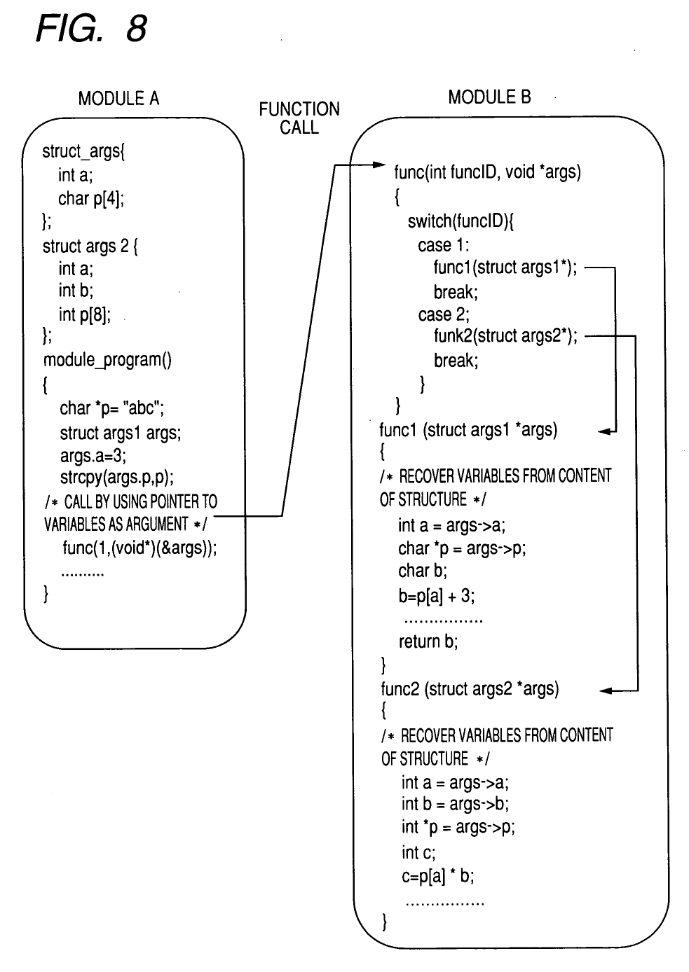

Thus, as shown in FIG. 8, in a module B, the functions to be called from a module A is defined by a common function func that has a function number and a structure as its pointer. In this common function func, a function number funcID can be used to call func1 or func2.

The above description has been given for C language by way of example. Of course, the above technique of the present invention may also be applied to languages other than C. This is because it has been proved in information mathematics, which is the basic theory for computers, that commonly used languages such as assembler, BASIC, C, C++, JAVA are equivalent in their description ability. This means that software written in any languages can be converted into software in other languages and therefore does not prevent application of the technique of the present invention to other languages.

II. Basic Technique of Hardware Implementation

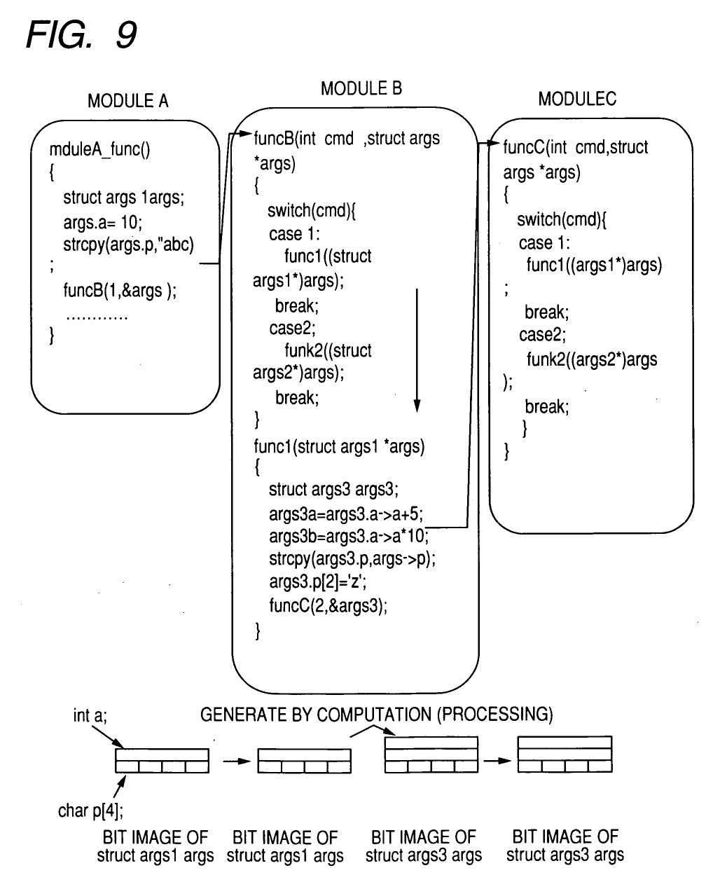

Now, the basic technique of implementing software by hardware according to the present invention will be described. A software module to be implemented by hardware in the present invention should be in the form shown in FIG. 8. Here, how argument structures are treated between modules will be described. FIG. 9 shows a typical example. Referring to a module B, a memory area corresponding to an argument args is indicated from outside (in this example, a module A). This area information is used to perform some computation or processing. Since the module B also typically calls a module C, the module B calls a function by specifying for the module C a pointer to an argument structure. Thus, a module receives an argument structure as an input, performs computation based on information written in the structure, and generates an argument structure for calling the next module. Every software program can be represented in this manner.

In the present invention, hardware implementation of a software module written in a programming language begins with implementing function portions in the main body of processing of func1 and func2 by hardware. The argument structures can be referred to from registers by the hardware corresponding to the function portions.

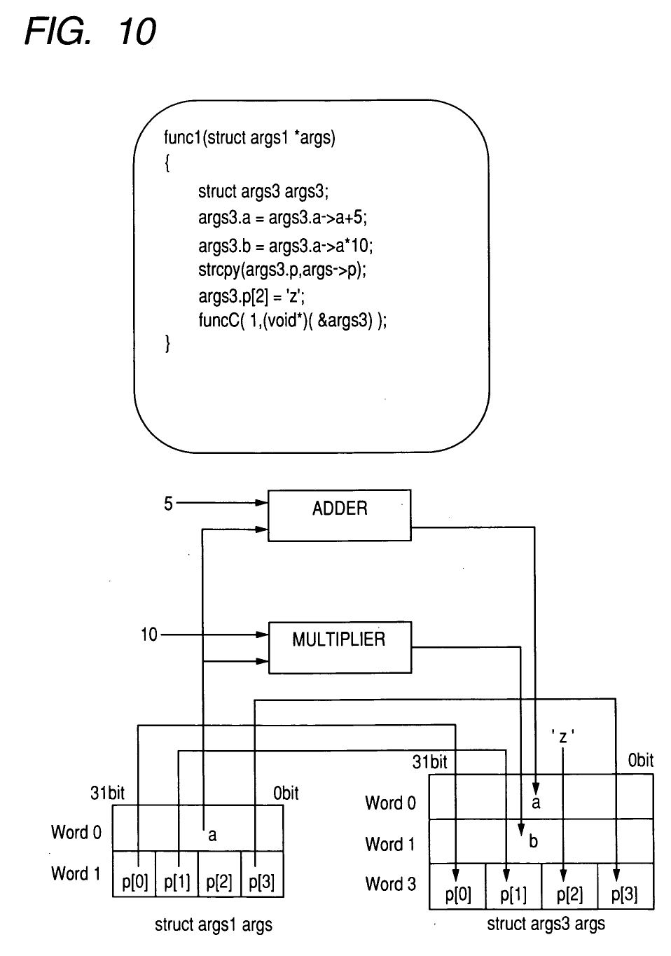

Thus, as shown in FIG. 10, there exist an input register corresponding to an argument structure as an input, and an output register corresponding to an argument structure for calling the next module. The hardware performs computation from the values of the input register and stores the result in the output register. The hardware may be implemented as either a hard-wired circuit or a state machine. A microprocessor, which allows programming of transitions and outputs of a state machine, may be used to compute the values of the output register from the input register.

III. Communication Between Hardware Modules

Further, communication between hardware modules according to the present invention will be described. In particular, a mechanism of a communication system between modules that is important in the present invention will be described. As described in the previous section, arguments for a function call between modules include a function number and a pointer to an argument structure. From the viewpoint of hardware that performs computation, the substance of an argument structure should be able to be referred to as output values of a register. Therefore, the hardware actually requires values that are the substance rather than a pointer. That is, hardware modules may communicate a function number and values that are the substance of an argument structure.

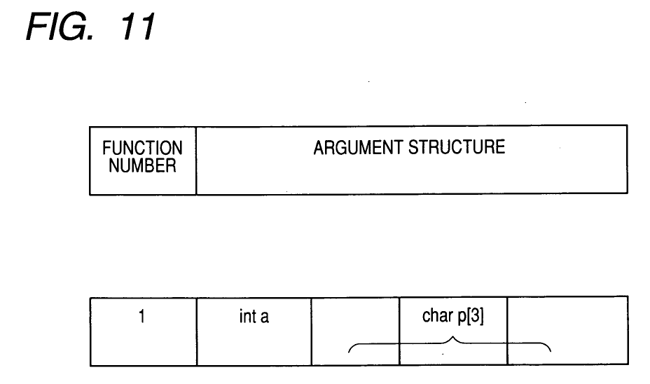

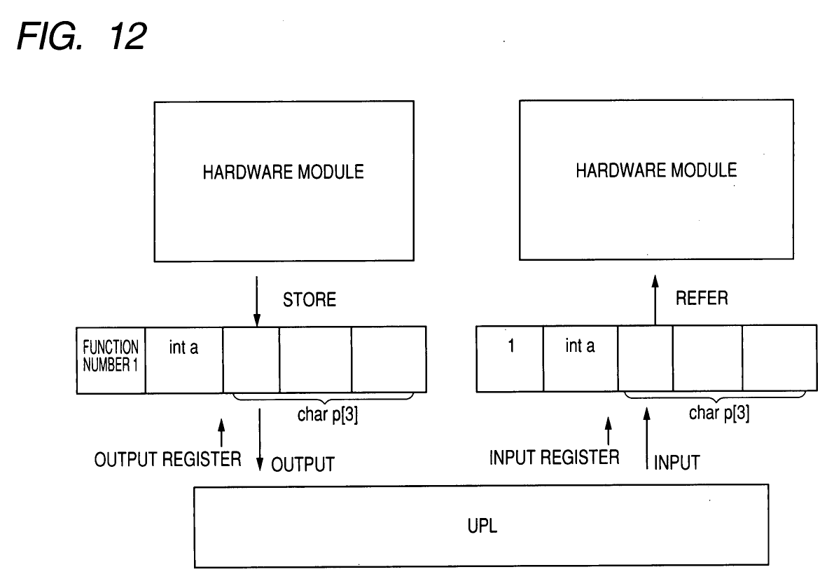

FIG. 11 shows an example of a packet communicated between modules. Data that consists of a function number and an argument structure is packed into a data unit called a packet, and communication between modules is performed on a packet basis. A function number is stored in the first word of the packet. Based on this number, it is determined which computation hardware module should have its input register reflect the argument structure. FIG. 12 shows an example of hardware that inputs or outputs a packet. Communication between the hardware modules employs what is referred to herein as Universal Protocol Line (UPL), via which the modules are connected to each other. UPL is a mechanism for transferring a value of an output register to an input register. UPL may be implemented by any schemes that meet conditions such as the transfer rate and transmission distance. For example, a commonly used serial transfer scheme, LVDS (Low Voltage Differential Signaling), a three-value logic scheme, Ethernet, USB, IEEE1284, or the Internet may be chosen.

The output register consists of a data section corresponding to a function number and an argument structure. Once the hardware module sets values in the output register, the values of the output register are output to UPL. Among packets received by the UPL, only those that should be received by this receiving module are set in the input register. Whether to be received or not can be determined by referring to the function number.

IV. Specific Examples of UPL Processing Circuit and UPL Merging Circuit

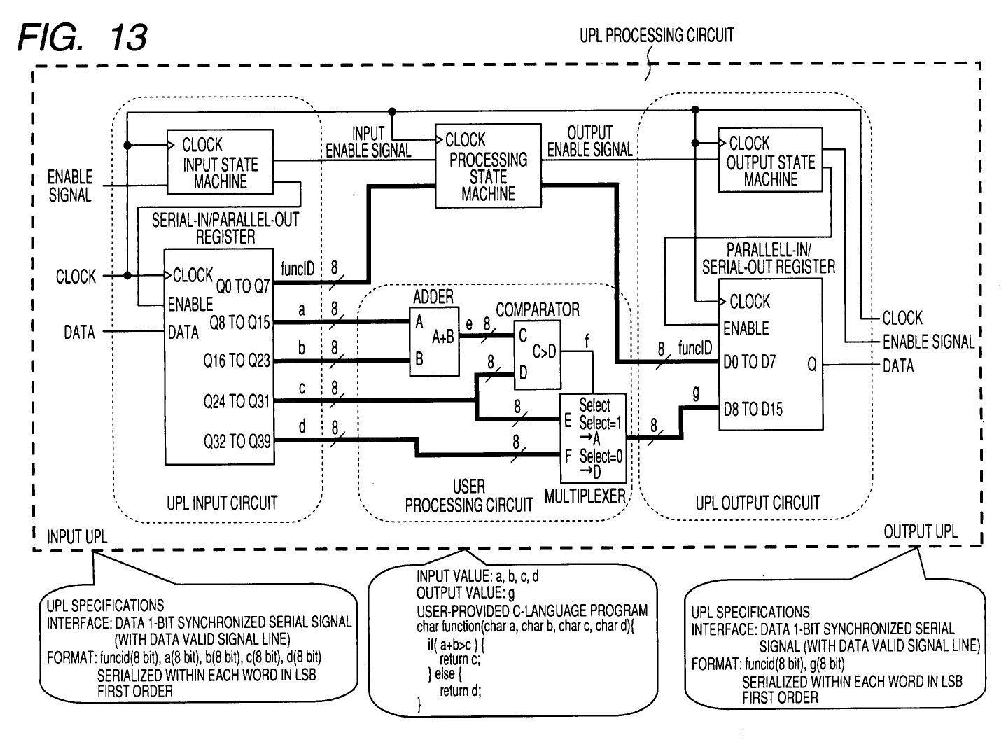

FIG. 13 shows a specific example of a UPL processing circuit. UPL packet data is input to the UPL processing circuit via a data signal line as an input UPL. The UPL packet data is converted in a UPL input circuit into data formats suitable for operational circuits for performing respective processing and is output to a user processing circuit. In the user processing circuit, the UPL packet data is subjected to certain processing such as certain operational processing and is output to a UPL output circuit. In the UPL output circuit, the output from the user processing circuit is converted into UPL packet data in accordance with the UPL specifications and is output as an output UPL. In this manner, the UPL packet data is transmitted between the UPL circuits. In addition, the data sent and received is subjected to control, such as timing control, by an enable signal and a clock.

More specifically, the UPL data packet that is input to the UPL input circuit is divided, in a serial-in/parallel-out register, into data input formats suitable for respective circuits. Bold lines shown indicate parallel signal lines of 8 bits. Then, a processing state machine evaluates data stored as funcID. If the input data is directed for its own circuit, input values a and b stored in the serial-in/parallel-out register are input to A and B of an adder for add operation. The output result e is input to C of a comparator. The comparator, which also receives an input value c at D, compares the magnitude of e and c. The comparator outputs f=1 if e>c, or outputs f=0 if e<c as an input value f to a multiplexer. Then, based on the value of f, the multiplexer outputs an input value c from E if f=1, or outputs an input value d from F if f=0 as an input value g to the UPL output circuit. Lastly, in the ULP output circuit, data indicating the next used circuit that is output from the processing state machine, as well as the value g that is output from the multiplexer are converted into and output as UPL packet data. If the data evaluated by the processing state machine is not directed to its own circuit, the UPL processing circuit does not perform any particular processing, thereby outputting no data. Although not shown here, a path may be provided for forwarding input data that is not directed to its own circuit through to the next circuit. In this example, the data line width of the input UPL is 1 bit. However, the data line width may be 2 bits, 3 bits, 40 bits that is the full data length, or even longer, for example 128 bits. A wider data line width requires less time for data transmission, but requires more lines between the UPL circuits. A designer may use an optimum data width considering specifications required for the circuits, characteristics of devices such as LSI devices used for implementing the circuits, physical constraints on wiring, and so on.

Components of the UPL processing circuit will be described in more detail below.

Input UPL

In this example, the input UPL is a clock-synchronized serial transmission path of a 1-bit data line. It is provided along with an enable signal line that indicates that the values on the data line are valid as data.

UPL Input Circuit

The UPL input circuit is a circuit that connects a set of UPL signal lines as input values to the user processing circuit.

Serial-In/Parallel-Out Register

The serial-in/parallel-out register consists of a clock-synchronized shift register. When the enable signal line is valid, the serial-in/parallel-out register sets input 1-bit data in order from Q0 to Q39.

Input State Machine

The input state machine receives an enable signal for the input UPL and controls the serial-in/parallel-out register. It also detects when the reception of a packet is completed. Once the reception is completed and therefore the values of funcID, a, b, c, and d are determined, the input state machine notifies the next processing state machine of this by outputting an input enable signal.

Processing State Machine

The processing state machine is a circuit that generates timing for determining output values after the input values are determined. It also controls determination timing for registers in the user processing circuit.

The processing state machine receives funcID as an input and determines whether or not the data is directed to its own circuit. If the data is directed to its own circuit, it controls operation of the processing circuit and provides outputs. Otherwise, it stops operation of the processing circuit and provides no outputs.

The processing state machine outputs the funcID to specify the next circuit to perform operation. In some cases, it changes the funcID according to a signal from the user processing circuit and dynamically changes the next circuit to perform operation depending on the processing result.

Input Enable Signal

The input enable signal is a signal line that indicates that the input values to the user processing circuit have been determined.

Output Enable Signal

The output enable signal is a signal line that indicates that the output values from the user processing circuit have been determined.

User Processing Circuit

The user processing circuit is a circuit that performs main processing intended by the UPL processing circuit. Typically, it is automatically generated by a compiler from a program written by a UPL apparatus designer in a programming language such as C. In some cases, it is directly written by a designer using a circuit description language such as VHDL or Verilog.

Output UPL

In this example, the output UPL is a clock-synchronized serial transmission path of a 1-bit data line. It is provided along with an enable signal line that indicates that the value on the data line is valid as data.

UPL Output Circuit

The UPL output circuit is a circuit that connects output values from the user processing circuit to a set of output UPL signal lines.

Parallel-In/Serial-Out Register

The parallel-in/serial-out register consists of a clock-synchronized shift register. When the enable signal line is valid, the parallel-in/serial-out register maintains input values from D0 to D15 in internal latches. It then outputs the values starting from D0 by one bit at each clock.

Output State Machine

The output state machine receives an output enable signal and controls transmission of packets. It controls the parallel-in/serial-out register and generates an enable signal for the output UPL.

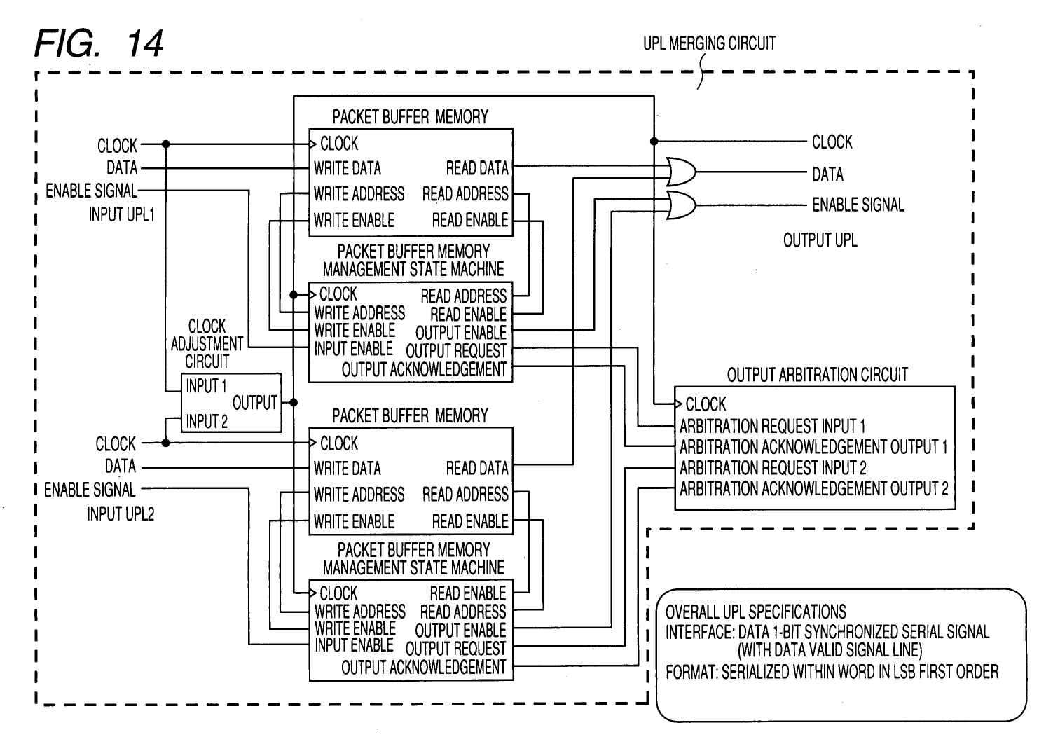

FIG. 14 shows a specific example of a UPL merging circuit. UPL packet data is input to the UPL merging circuit via data lines, namely an input UPL1 and an input UPL2, which have their timing adjusted by a clock adjustment circuit. The input data from the input UPLs is maintained in respective packet buffer memory. Read/write operations on the packet buffer memory are controlled by packet buffer memory management state machines connected to respective packet buffer memory. The packet buffer memory management state machines are further connected to an output arbitration circuit. The UPL packet data that is input via the input UPL1 and the input UPL2 is output from a single output UPL as UPL packet data with its timing adjusted by the output arbitration circuit. In addition, the data sent and received is subjected to control, such as timing control, by an enable signal and a clock.

Components of the UPL merging circuit will be described in more detail below.

Input UPL1 and Input UPL2

In this example, the input UPL1 and the input UPL2 are clock-synchronized serial transmission paths of 1-bit data lines. Each of them is provided along with an enable signal line that indicates that the values on the data line are valid as data.

Packet Buffer Memory

The packet buffer memory is memory that temporarily stores packets that are input from the input UPLs.

Packet Buffer Memory Management State Machine

The packet buffer memory management state machine controls read/write operations on the packet buffer memory and controls the enable signal line of the output UPL.

If a plurality of packet buffer memory units simultaneously provide outputs, the packet data may be corrupted. Therefore, a mechanism for exclusive processing is required. To achieve this, a request for arbitration is issued to the output arbitration circuit, so that an output is provided to the output UPL only when permitted.

Output Arbitration Circuit

The output arbitration circuit receives arbitration request inputs from a plurality of circuits and returns arbitration acknowledgement outputs to the requesting circuits. When the output arbitration circuit simultaneously receives the arbitration request inputs, it returns only one arbitration acknowledgement output at a time.

Output UPL

This is the output UPL of the UPL merging circuit and outputs packets received from a plurality of input UPLs without changing values.

V. Applications of the Present Invention

Using the above-described technique of the present invention, various data processing apparatus conventionally implemented by software can be easily implemented by hardware. Specific applications will be described below.

Internet Server

There are computers called servers that provide services on the Internet. A server is a computer that receives various requests from client computers connected to it over the Internet and returns data to the clients according to the requests. This computer has operating system software and server software running thereon. An enormous amount of requests are imposing intensive loads on server computers because of explosive expansion of the Internet, increase in the number of client computers, and exponential speedup of access lines due to ADSL, SDSL, Fiber optics, and so on.

Conventionally, the amount of requests processible by a server computer has been arithmetically increased by enhancement of processing ability of hardware such as a CPU and memory of a server computer, as well as software improvements. However, the increase in requests is now outreaching the processing ability, and it is often observed that a server computer fails to function and stops services because the increase in requests has already temporarily outreached the processing ability.

In this case, high speed processing can be accomplished by applying the technique of the present invention to such an information processing apparatus so that the operating software and the server software running on the server are replaced with hardware. This also applies to other apparatus, such as routers and client machines.

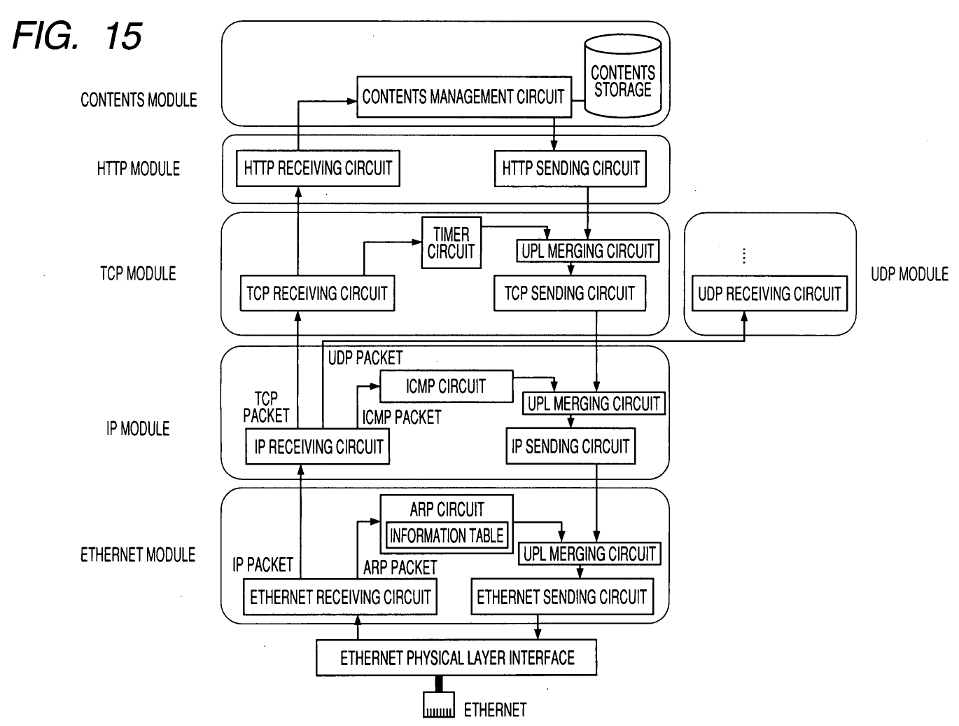

As an example for the server software, FIG. 15 shows exemplary hardware implementation of a web server. An Ethernet receiving module processes Ethernet packets received by an Ethernet physical layer interface, which is a kind of LAN, and outputs the packets to a UPL. Connected to the UPL are an ARP module for processing ARP (Address Resolution Protocol) and an IP module for processing IP (Internet Protocol). Depending on a value of the protocol identifier of the Ethernet packets, packets with varying protocol codes are generated. This allows determination as to whether the packets sent from the Ethernet module to the UPL is to be processed by the ARP module or the IP module.

An ARP circuit in the Ethernet module is a module responsible for sending an ARP reply packet when an ARP request packet is received. Referring to an Ethernet packet contained in the data section, as well as an information table that stores information such as its own IP address, it determines whether or not to send a reply packet and determines the content of the reply packet. The reply packet is then sent to an Ethernet sending module.

An IP receiving circuit in the IP module receives an IP packet and checks its checksum and whether or not to accept the IP packet. Further, in accordance with the protocol of the IP data section, it performs branch processing to direct the packet to a TCP module if the packet is a TCP packet, or to a UDP module if the packet is a UDP packet. At this point, information required for processing in the upper layer, such as the IP address and the packet length, is extracted from the IP header and sent as an IP layer incomplete header along with the IP layer data. Other kinds of processing are also performed as appropriate, such as recovering a fragmented packet and forwarding a packet that is not directed to the IP module. UPLs from the TCP module, an ICMP circuit, and other circuits are integrated by a UPL merging circuit, which is connected to an IP sending circuit in the IP module. Information about the destination is provided from the former module such as the TCP module as an IP layer incomplete header. From this information, the IP sending circuit generates an IP layer complete header and outputs it to the Ethernet sending circuit. The TCP module performs protocol processing as defined in TCP, and the HTTP module performs protocol processing as defined in HTTP.

A content module stores web data to be returned from the web server to client computers. Various storage devices connectable to electric circuits may be used as storage means, including electric storage devices such as flash memory and static memory, as well as magnetic storage devices such as a hard disk.

OSI Seven-Layer Model

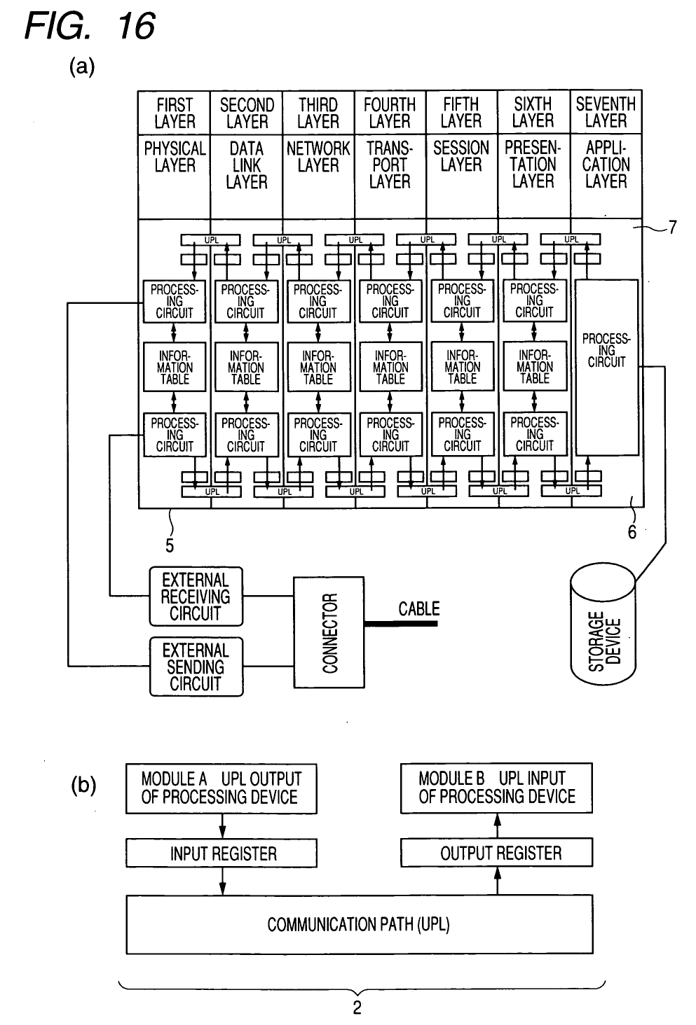

FIG. 16 (a) shows an example in which UPL of the present invention is applied to the OSI seven-layer model, a basic concept of networks. As shown, the OSI seven-layer model includes the first layer (physical layer), second layer (data link layer), third layer (network layer), fourth layer (transport layer), fifth layer (session layer), sixth layer (presentation layer), and seventh layer (application layer). Each layer is connected by an Nth layer sending circuit 7 and an Nth layer receiving circuit 6 to communicate with the adjacent layers using a transmission scheme in accordance with the UPL standards. The layers are also connected to an external network via an external receiving circuit and an external sending circuit connected to processing circuits of the first layer and further via a connector and a cable. Any transfer schemes well known to those skilled in the art may be used for communication with the external network. FIG. 16 (b) shows an enlarged view of a connection between two adjacent layers of the OSI seven-layer model. A UPL packet is output from a UPL output of the processing device of a module A in an Nth layer. The UPL packet is then sent via an input register, a communication path, and an output register to a UPL input of the processing device of a module B in an Mth layer (M=N+1 or N−1).

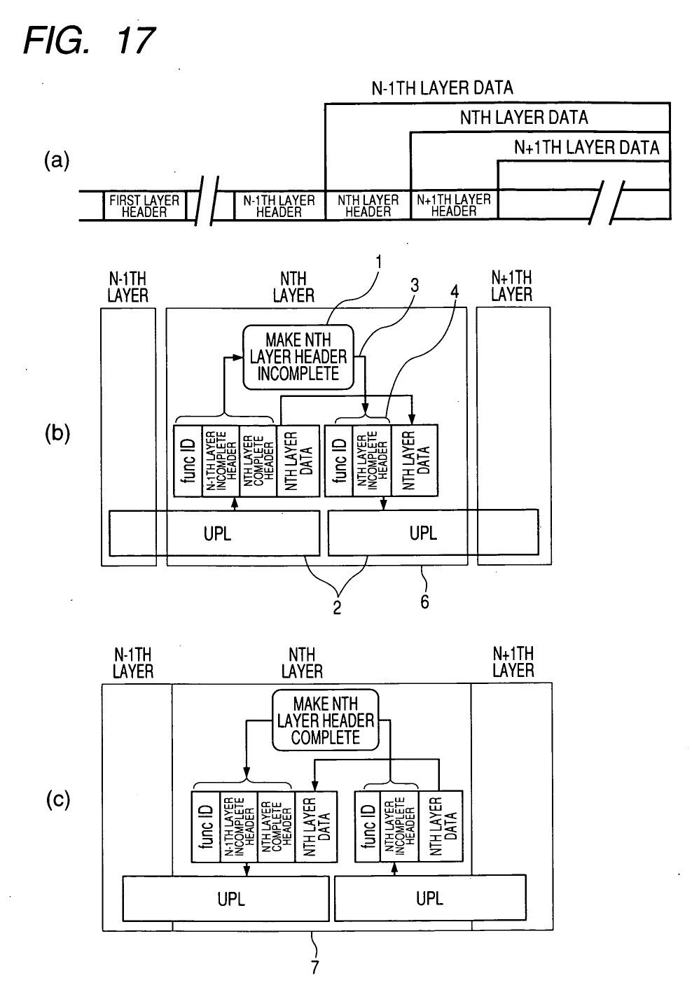

For example, the data packet used here has a structure shown in FIG. 17 (a). FIG. 17 (b) shows the receiving circuit 6 in an Nth layer. Information required for processing of the Nth layer extracted from complete headers of layers up to the N−1th layer is called herein “N−1th layer incomplete header information” (a complete header contains header information configured in accordance with communication protocol rules). Generally, “N−1th layer data” can be considered in the Nth layer as “Nth layer complete header” and “Nth layer data.” In the Nth layer, “Nth layer incomplete header information” required for processing of the N+1th layer is generated from “N−1th layer incomplete header information” and “Nth layer complete header information.” The “Nth layer incomplete header information” generated and “Nth layer data” are then sent to the N+1th layer via the UPL. In sending processing, reverse operation of this processing is performed. FIG. 17 (c) shows the sending circuit 7 in an Nth layer. From the N+1th layer, “Nth layer incomplete header information” and “Nth layer data” are sent to the Nth layer via the UPL. In the processing circuit of the Nth layer, information maintained in the Nth layer is added to the “Nth layer incomplete header information” to generate “Nth layer complete header information.” Then, the “Nth layer complete header information” and the “Nth layer data” are combined to form “N−1th layer data.” Also, “N−1th layer incomplete header information” is generated. The “N−1th layer incomplete header information” and the “N−1th layer data” are sent to the N−1th layer via the UPL.

In this manner, in an information communication processing apparatus in the Internet environment, the present invention employs both communication processing devices that involve making a header complete and incomplete and UPL devices instead of employing conventional seamless CPU processing. This allows effective hardware implementation of communication processing software of the communication information processing apparatus and achieves high-speed processing of communication protocols. As a result, communication processing at wire speed is possible.

Communication information processing that involves making a header incomplete herein means a technique for speeding up processing by integrating and abstracting information from an external output to only what is required in the next circuit. In this respect, although the amount of information is reduced compared to the original amount of information, the speed of protocol processing can be increased because internal processing allows the information to be intentionally integrated and abstracted to only what is required for information transmission and made incompleted. This technique may be used for smooth protocol processing in information processing apparatus.

As described above, according to the present invention, the UPL devices can be used for hardware implementation of input/output processing of each layer in the OSI seven-layer model. With respect to the output, on the hardware, the above-described UPL devices and the information processing devices that involve making a header incomplete can be used to recover complete header information from incomplete header information. Then, referring to an information table as necessary, required information can be quickly sent to a requesting device along with the header information.

Other Applications

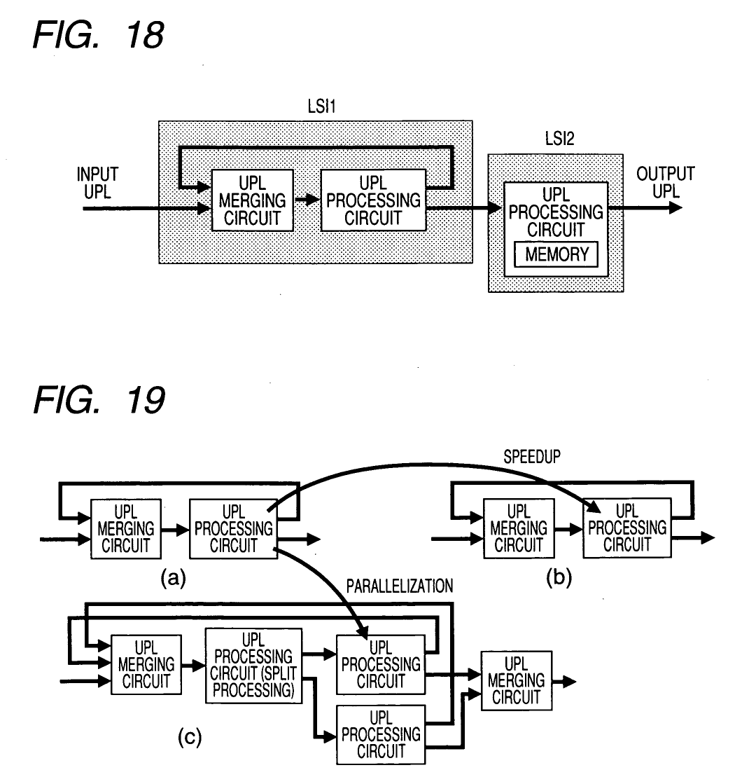

According to another application (a) of the present invention, as shown in FIG. 18, depending on the traffic amount among circuits and physical constraints among LSI devices, arbitrarily selected one or more UPL processing circuits (and UPL merging circuits) can be mounted on a single LSI device to form a UPL apparatus as a combination of a plurality of LSI devices. For example, on LSI1, a UPL merging circuit having a plurality of inputs (two inputs in this figure) simply merges output packets from two or more circuits into one packet and outputs it. Then, the following UPL processing circuit performs certain processing (such as computation) and outputs the result as a packet, which is sent to the following LSI2. In this example, one of the outputs of the UPL processing circuit is fed back to the UPL merging circuit.

According to another application (b) of the present invention, a circuit shown in FIG. 19 (a) is bottlenecked by the processing speed of a UPL processing circuit. This bottlenecking processing speed of the UPL processing circuit can be easily improved by increasing the processing speed of the UPL processing circuit alone as shown in FIG. 19 (b), or by arranging UPL processing circuits in parallel as shown in FIG. 19 (c). Thus, the overall processing ability of the apparatus can be improved without modifying implementation of other circuits.

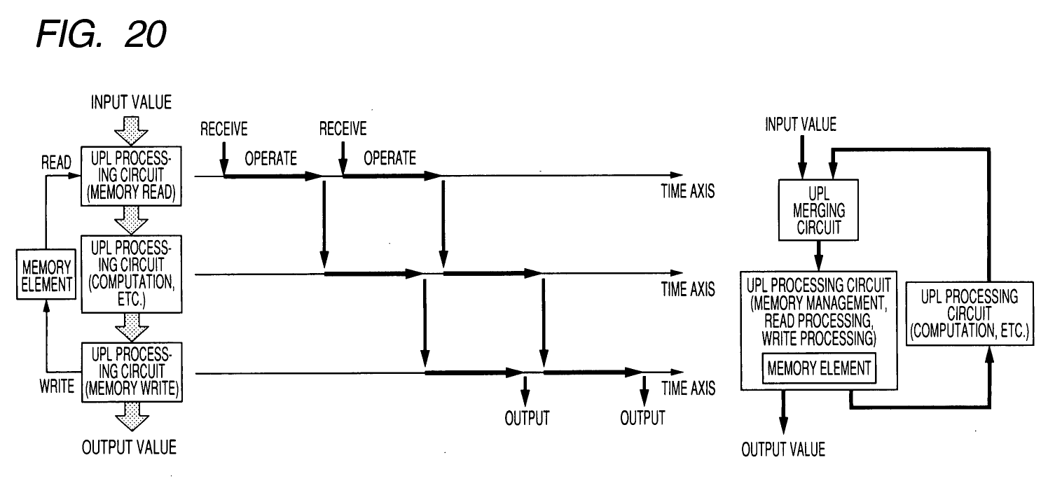

A memory access circuit according to another application (c) of the present invention is shown in FIG. 20. As shown, the memory access circuit, which is an application of the UPL processing circuit of the present invention, is divided into UPL processing circuits for performing memory read, memory write, and processing such as computation. Therefore, as shown in FIG. 20, the memory access circuit can perform pipeline processing and achieve faster processing than in conventional manner (conventionally, a series of operations of memory read, computation, and memory write is completed before proceeding to the next processing). In an actual circuit, as shown in FIG. 20, memory management such as exclusive processing may be performed in a single processing circuit.

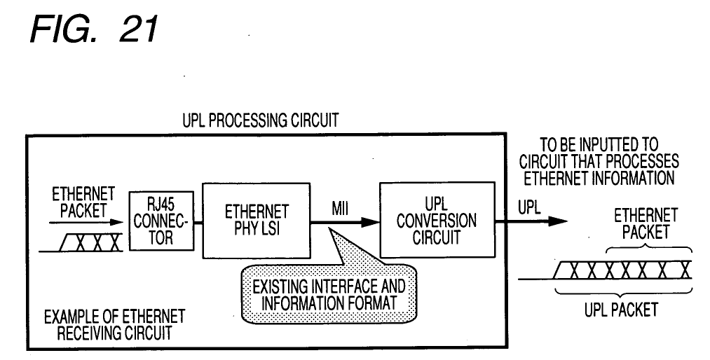

Another application (d) of the present invention is shown in FIG. 21. As shown, in a UPL processing circuit, external information in an existing data format (such as an Ethernet packet) can be converted and encapsulated into a UPL packet. Thus, data formats that are apparently different from UPL can be accommodated in the UPL framework, and a circuit for processing the existing data formats can be configured.

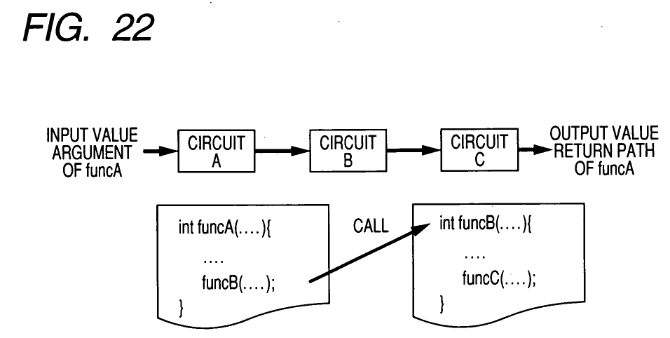

Another application (e) of the present invention is shown in FIG. 22. As shown, since the UPL apparatus according to the present invention is highly compatible with programming languages, functions (methods) in languages such as C, C++, and Java can be associated with UPL processing circuits. Debugging can also be easily performed on a UPL processing circuit basis.

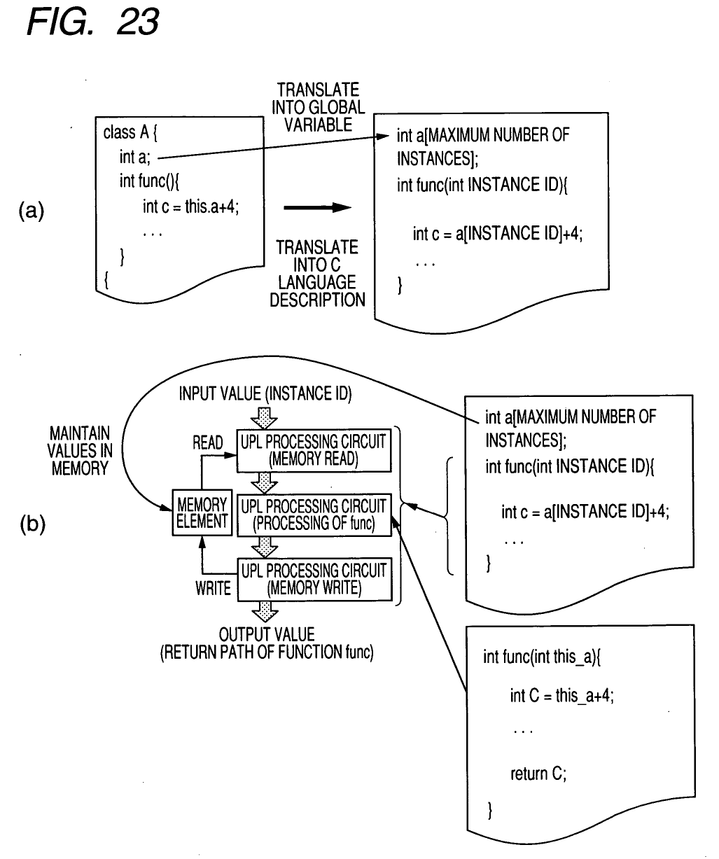

Another application (f) of the present invention is shown in FIG. 23. As described above, object-oriented software can be easily implemented as hardware by a combination of provision of highly efficient memory access and hardware implementation of methods. In the example shown in FIG. 23 (a), object-oriented software (Java language in this example) is translated into C language (a class variable and an instance variable are translated into global variables, and an instance ID indicating an instance of the class is specified upon calling a function). Then, it is converted into hardware circuitry. It is also possible to convert object-oriented software directly into hardware circuitry. FIG. 23 (b) shows hardware implementation of a specific C language program. As shown, hardware implementation can be achieved by storing class variables and instance variables in memory elements of the above-described UPL memory access circuit, and associating functions with UPL processing circuits as described above.

In the above examples, methods of implementing the entire software program by hardware have been described. However, if this hardware implementation is not beneficial in other points such as speed and cost, some of the functional units may not be implemented by hardware and may be performed by a general-purpose computer. The computer may be provided with a UPL input/output device for connecting the hardware part based on the UPL specifications and the software part performed by the general-purpose computer, so that the two parts coexist.

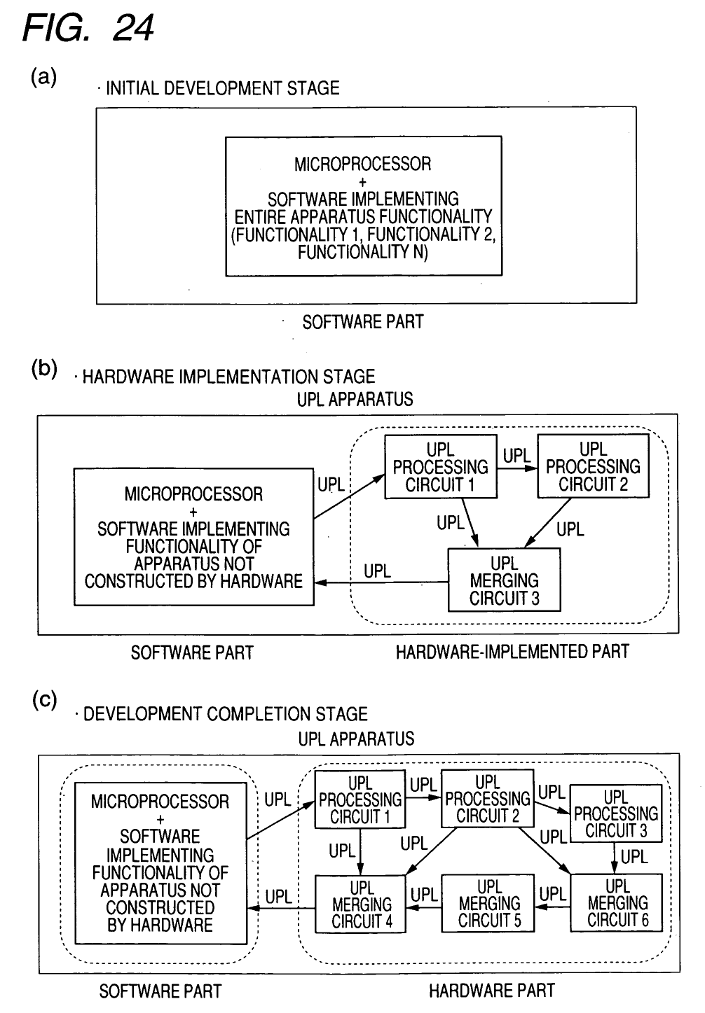

Referring to FIG. 24, a concept of this coordinative development of hardware and software in a UPL apparatus will be described. First, in the initial stage shown in FIG. 24 (a), a program is configured in which all of n pieces of functionality (software functionality 1, software functionality 2, software functionality 3, . . . , software functionality n) of the apparatus is written as software. At this point, it should be ensured that the software program configuration causes no errors (in terms of algorithms, data structures, and divisions between pieces of functionality). This software program configuration may also be performed by a typical microcomputer.

Next, in a hardware stage shown in FIG. 24 (b), replacement with hardware is performed sequentially from where it is replaceable, while verifying operation of the apparatus. That is, part of the functionality configured as software is replaced with UPL processing circuits (and UPL merging circuits), which are hardware based on the UPL specifications described above. (In this figure, the software functionality 1, 2, and 3 are replaced with UPL processing circuits 1, 2, and 3 respectively. Although not shown, the software part is executed by a computer such as a conventional microcomputer. To connect the hardware part based on the UPL specifications and the computer part, a device is interposed that converts inputs and outputs of the computer into those in accordance with the UPL specifications.) At this point, verification may be performed for both the hardware alone and the entire apparatus. While operation is verified, the hardware replacement process is continued: pieces of functionality configured as software are replaced with UPL processing circuits (and UPL merging circuits). Since operation of the UPL processing circuits are rather independent of each other, concentrated debugging can be performed for those portions implemented by hardware. The UPL processing circuits can be developed separately from each other, and if each of them fully operates, the entire combination of them also fully operates. If a malfunction occurs after addition of a UPL processing circuit, that UPL processing circuit is the cause of the malfunction. Therefore, it is easy to locate malfunctioning portions. Another feature is the ease of debugging within each UPL processing circuit, since each UPL processing circuit is small in size compared to the entire apparatus.

Finally, a development completion stage is shown in FIG. 24(c). This stage is where the separation of hardware and software is accomplished as initially intended. An apparatus in which the entire functionality is implemented by hardware does not have the microprocessor part (software part). Operational verification may also have been completed when this stage is reached, so that operational verification can be performed at any points before this stage.

### INDUSTRIAL APPLICABILITY

According to the present invention, the following functional advantages can be achieved.

(1) The hardwired circuits without software can speed up processing operation. For example, in the above-described Internet server application, a situation is avoided where the overloaded server cannot process all information and results in stopping its processing. The server can instantaneously process information at a gigabit level and make the Internet infrastructure reliable.

(2) Circuit design can be provided with flexibility, which facilitates modifications and enhancements of processing capability.

(3) Since division into circuits is easy, the circuits can be implemented by a plurality of middle-scale general-purpose integrated circuits and large-scale gate arrays (for example, FPGAs) rather than by special-purpose LSI devices such as ASICs.

(4) High compatibility with programming languages is provided, and object-oriented software can be easily implemented by hardware.

(5) UPL is an integrated interface of software and hardware. This facilitates coordination between hardware and software, advanced development of hardware, and rapid and low-cost development even if the resulting apparatus is complex.

1. A hardware-implemented information processing apparatus comprising:
a plurality of processing circuit modules, each performing specific information processing in response to input of information data;
a merging circuit module that merges information data from a plurality of paths into one path; and
transmission means for performing one-way transmission of the information data in a data set form to/from the processing circuit modules, to/from the merging circuit module, and between the processing circuit modules and the merging circuit module.

2. A hardware-implemented information processing apparatus comprising one or more processing circuit modules and zero or one or more merging circuit modules,
wherein the processing circuit modules and the merging circuit modules perform one-way information transmission of data sets containing certain information to/from the processing circuit modules, the merging circuit modules, or an I/O interface;
wherein each of the processing circuit modules has a circuit for performing a function specific to the module and has zero or one input and zero or more outputs; and
wherein each of the merging circuit modules has two or more inputs and one output and merges output data sets from two or more circuits into one output.

3. An information processing apparatus comprising:
a plurality of hardware modules, each configured by implementing one of functional units of certain information processing software as hardware; and
transmission means for performing one-way transmission of data between the hardware modules on a data set basis.

4. The information processing apparatus according to claim 3 wherein each functional unit of the software corresponds to a software component in which header and data information is communicated and processing is performed by, for example, a function call in C language.

5. The information processing apparatus according to any of claims 1 to 4, the apparatus having an Internet server function.

6. The information processing apparatus according to any of claims 1 to 4, the apparatus by having one of the functions of data mining, natural language processing, network information processing, a DNA computation simulator, physical simulation, and audio and video processing.

7. A method of manufacturing an information processing apparatus, the method comprising the steps of:
dividing a software program that implements a certain information processing function on a general-purpose computer into one or more arbitrary functional units;
providing a hardware-implemented processing circuit module that has zero or one input and zero or one or more outputs communicating the functional units via data sets of an arbitrarily fixed or variable length, and operates based on the data sets to perform certain processing corresponding to one of the functional units provided by dividing; and
providing a hardware-implemented merging circuit module that has a plurality of inputs and one output and operates to merge inputs of the data sets from the inputs into one output;
wherein one or more of the processing circuit modules are combined with each other and optionally the inputs and the output of one or more of the merging circuit modules are further combined therewith so that processing operation implemented by the software program and the general-purpose computer is implemented by hardware circuits.

8. The method according to claim 7, wherein the processing circuit module is configured as a gate array.

9. The method according to claim 7, wherein the data set includes a header section and a data section, the header section containing information for the processing circuit module to control another processing circuit module connected directly or indirectly thereto.

10. The method according to claim 7, wherein the merging circuit module includes a storage device for temporarily storing the input data sets.

11. The method according to claim 7, wherein the processing circuit module and the merging circuit module include means for feeding back a processing state of the input data sets.

12. A method of manufacturing an information processing apparatus, the method comprising the steps of:
dividing a software program that implements a certain information processing function on a general-purpose computer into one or more functional units;
selecting functional units to be implemented by hardware among the functional units provided by dividing;
providing a plurality of hardware-implemented processing circuit modules, each having zero or one input and zero or one or more outputs that communicate the functional units via data sets of an arbitrarily fixed or variable length, and operating to perform processing corresponding to one of the selected functional units; and
providing a hardware-implemented merging circuit module that has a plurality of inputs and one output and operates to merge inputs of the data sets from the inputs into one output;
wherein one or more of the processing circuit modules are combined with each other and optionally the merging circuit modules is further combined therewith so that entire processing operation of the software program is implemented by a combination of hardware circuits and a software part implemented by the general-purpose computer.

13. The method according to claim 12, wherein in the step of combining the processing circuit modules and optionally the merging circuit module with the software part, the functional units to be replaced in the software program are replaced one by one with the processing circuit modules or the merging circuit module while being verified for operation.

14. An apparatus comprising a circuit manufactured with the method according to any of claims 7 to 13.
